(19) United States
(12) Patent Application Publication
(10) Pub. No.: US 2026/0367963 A1
(43) Pub. Date: Nov. 19, 2026

(54) GENERATING A DATA PIPELINE FROM MEDIA INPUT

(71) Applicant: Microsoft Technology Licensing, LLC, Redmond, WA (US)

(72) Inventors: Wee Hyong TOK, Seattle, WA (US); Abhishek NARAIN, Woodinville, WA (US); Ting Wei LEE, Redmond, WA (US); Xuping ZHOU, Shanghai (CN); Gust VERBRUGGEN, Keerbergen (BE); Clint SIMON, Snoqualmie, WA (US); Vu Minh LE, Redmond, WA (US); Fang LIU, Shanghai (CN); Wang ZHANG, Shanghai (CN); Xin YANG, Shanghai (CN)

(21) Appl. No.: 19/249,148

(22) Filed: Jun. 25, 2025

Related U.S. Application Data
(60) Provisional application No. 63/805,220, filed on May 13, 2025.

(51) Int. Cl. G06F 9/48; G06F 9/451

(52) U.S. Cl. CPC G06F 9/4843; G06F 9/451

(57) ABSTRACT

Methods, apparatuses, and products for generating a data pipeline from media input, the method comprising: receiving, by a computing system, a media input comprising a representation of a data processing workflow; analyzing, by the computing system, the media input using one or more artificial intelligence models to detect a plurality of pipeline components; determining, by the computing system, an arrangement of the pipeline components based on relationships inferred from the media input; and generating, by the computing system, a data pipeline definition comprising the pipeline components and their arrangement for execution within a processing environment.

### BACKGROUND

Creating data integration workflows can involve constructing pipelines that extract, transform, and load data into various destinations. Existing tools that are used to construct pipelines, however, generally lack the ability to interpret input modalities that pipeline creators use when designing a pipeline. For example, if a pipeline creator illustrates a pipeline on a whiteboard, existing tools that are used to construct pipelines cannot examine those whiteboard drawings and ultimately transform them into executable pipeline logic. Instead, pipeline creators must interact directly with the pipeline creation tools themselves using interfaces provided by the pipeline creation tool, thereby causing the pipeline creator to duplicate work and potentially lose context from design and brainstorming sessions.

### SUMMARY

According to embodiments of the present disclosure, various methods, apparatus, and products for generating a data pipeline from media input are described herein. In some aspects, generating a data pipeline from media input includes: receiving, by a computing system, a media input comprising a representation of a data processing workflow; analyzing, by the computing system, the media input using one or more artificial intelligence models to detect a plurality of pipeline components; determining, by the computing system, an arrangement of the pipeline components based on relationships inferred from the media input; and generating, by the computing system, a data pipeline definition comprising the pipeline components and their arrangement for execution within a processing environment. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a flow chart illustrating an example of a computer-implemented method for generating a data pipeline from media input in accordance with some embodiments of the present disclosure.

FIG. 2 sets forth a flow chart illustrating an additional example of a computer-implemented method for generating a data pipeline from media input in accordance with some embodiments of the present disclosure.

FIG. 3 sets forth a flow chart illustrating an additional example of a computer-implemented method for generating a data pipeline from media input in accordance with some embodiments of the present disclosure.

FIG. 4 sets forth a flow chart illustrating an additional example of a computer-implemented method for generating a data pipeline from media input in accordance with some embodiments of the present disclosure.

FIG. 5 sets forth a flow chart illustrating an additional example of a computer-implemented method for generating a data pipeline from media input in accordance with some embodiments of the present disclosure.

FIG. 6 sets forth a flow chart illustrating an additional example of a computer-implemented method for generating a data pipeline from media input in accordance with some embodiments of the present disclosure.

FIG. 7 sets forth a flow chart illustrating an additional example of a computer-implemented method for generating a data pipeline from media input in accordance with some embodiments of the present disclosure.

FIG. 8 sets forth an example of a computing device that may be used for some portion of generating a data pipeline from media input in accordance with some embodiments.

FIG. 9 sets forth a block diagram of a cloud service provider service architecture in accordance with some embodiments of the present disclosure.

### DESCRIPTION OF EMBODIMENTS

Data pipelines are a foundational element of modern analytics and operational systems. These pipelines coordinate the movement and transformation of data from disparate sources into other formats, such as formats for data destinations such as a data warehouse, data lakehouse, database system, Software-as-a-Service (‘SaaS’) system, or other data destination. While most data integration tools offer graphical interfaces or text-based copilots for pipeline construction, the ideation and planning stages for developing such pipelines often begin elsewhere. For example, teams frequently outline workflows through whiteboard sketches, diagrams found in documentation, or spoken explanations during design sessions. Bridging the gap between these informal artifacts and executable pipelines has historically been a manual, time-consuming process.

The embodiments described here provide techniques for converting non-traditional inputs (e.g., visual inputs, auditory inputs) into structured pipeline definitions. In some embodiments, a computing system may receive an image that contains a representation of a pipeline. The system can interpret the image using a model capable of understanding spatial relationships, visual annotations, and text. The system may then generate a corresponding pipeline layout. Alternatively, the system may accept a spoken description, transcribe the audio, extract task intent and sequencing, and use this information to generate a pipeline structure. These approaches enable users to initiate pipeline creation using media that best reflects the way their ideas were first expressed.

In some implementations, the system recognizes the types of activities depicted in an image and assigns appropriate labels or roles based on familiar patterns. It may also infer logical relationships between components, such as conditional flows or task dependencies. The resulting pipeline structure may be composed of placeholders that reflect the inferred intent of the source material (e.g., visual inputs, auditory inputs). Once generated, the structure can be edited, completed, or deployed into a data integration environment. This allows users to move seamlessly from a conceptual artifact to a working system without rebuilding the logic from scratch.

In some embodiments, the systems described here n include features that refine the generated pipeline by comparing it to common architectural practices. The system may suggest adjustments that align with known design strategies or best practices. These adjustments may be integrated automatically or offered as guidance during subsequent editing stages. The result is a pipeline that not only matches the user's input but also reflects well-understood patterns that support maintainability, performance, or some other objective.

By processing non-traditional inputs like video, images, and audio, the system reduces reliance on rigid, syntax-bound interfaces and enables more flexible forms of user interaction. This removes the need for manual reconstruction of pipeline logic from visual or verbal artifacts, allowing a computing system to extract structure, interpret relationships, and generate executable workflows with minimal user intervention. The use of multimodal inputs and multimodal analysis models allows the system to detect visual elements, spatial arrangements, and contextual cues that represent data flow logic. This enables automatic generation of valid pipeline structures that are syntactically complete, logically coherent, and aligned with the capabilities of the target integration environment. The system also supports real-time validation of input quality, detection of unsupported formats, and optional refinement through user input, creating a seamless transition from high-level design intent to operational pipeline definitions.

Readers will appreciate that a platform that implements these techniques may reduce development timelines, improve onboarding, and enable smooth transitions from legacy systems. When used in a migration context, the ability to extract logic from screenshots or interface captures allows older workflows to be reconstructed without direct code or file access. From a product standpoint, offering multimodal pipeline generation can distinguish a service by emphasizing adaptability, speed, and accessibility in data operations.

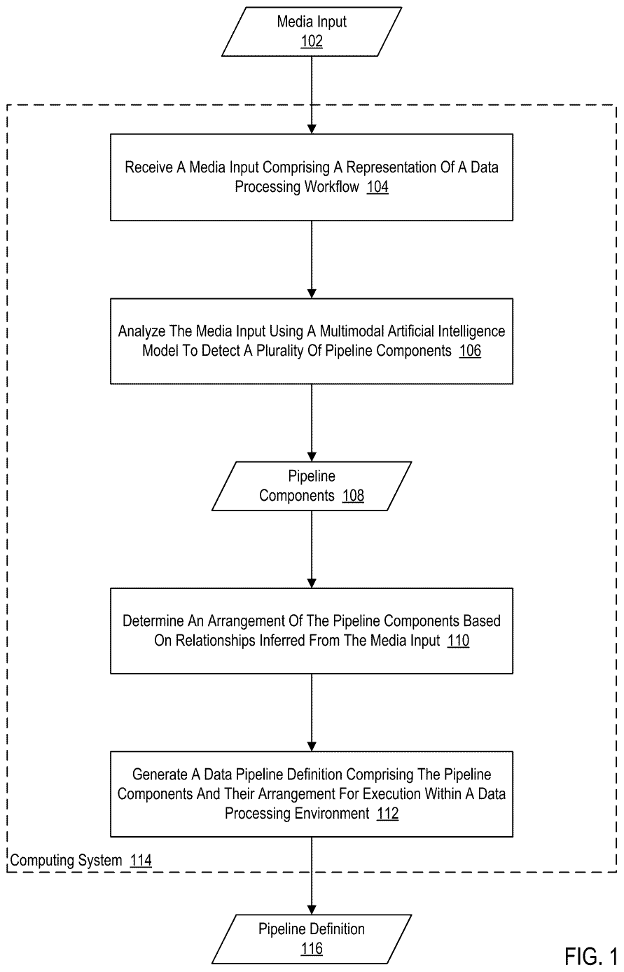

For further explanation, FIG. 1 sets forth a flow chart illustrating an example of a computer-implemented method for generating a data pipeline from media input in accordance with some embodiments of the present disclosure. The computing system 114 may include one or more processors configured to execute instructions stored in memory that enable the functionality described herein. The computing system 114 may also include data storage components, such as persistent storage or volatile memory, used for storing models, intermediate results, and pipeline definitions. In some embodiments, the computing system 114 includes specialized hardware for media analysis tasks, such as graphical processing units for accelerating artificial intelligence model inference. The computing system 114 may also include input and output interfaces for receiving media input from users or external services and for delivering pipeline outputs to execution environments. The computing system 114 may operate locally, remotely, or across a distributed infrastructure, and may be implemented in cloud platforms, on-premises servers, edge devices, or a combination thereof.

The computing system 114 may generate a data pipeline as described in greater detail below. A data pipeline can refer to a logical sequence of operations that extract, process, and deliver data from one or more sources to one or more destinations. Each operation in the pipeline may be represented as a component or activity that performs a specific function, such as reading from a file system, transforming the format or structure of the data, filtering or aggregating records, applying conditional logic, or writing to a database or storage location. Data pipelines may support linear flows, branching logic, parallel paths, or iteration over datasets. In some embodiments, a data pipeline is defined in a machine-readable format suitable for deployment within a processing environment that manages scheduling, execution, error handling, and monitoring.

The example method depicted in FIG. 1 includes receiving 104, by a computing system 114, a media input 102 comprising a representation of a data processing workflow. In some embodiments, the computing system 114 receives 104 a media input 102 that represents a data processing workflow. The term “media input” can refer to digital content that conveys information visually, audibly, or both. This can include, for example, images (e.g., digital photographs of whiteboard sketches, screenshots of user interface diagrams), audio recordings (e.g., spoken descriptions of a desired pipeline), video recordings (e.g., tutorial videos, product demonstrations, or walkthroughs in which pipeline behavior is described or illustrated).

The media input 102 may be received 104 through a variety of channels. For example, a user may upload a file from local storage via a graphical user interface, submit content through an application programming interface (‘API’), capture a live recording using a connected camera or microphone, or in other ways. In some implementations, the computing system 114 may also support drag-and-drop functionality or integration with cloud-based repositories (such as document libraries or shared drives) to facilitate streamlined content selection. In some implementations, the computing system 114 may also receive 104 the media input 102 from automated sources, such as preconfigured integrations with external systems, scheduled import tasks, or event-triggered uploads, without direct user initiation.

The media input 102 of FIG. 1 comprises a representation of a data processing workflow. This representation may take the form of labeled blocks, arrows, or other visual markers that suggest the existence of components such as data sources, transformations, and destinations. In audio or video inputs, the representation may be implicit in natural language descriptions, such as references to moving data between systems, applying transformations, or handling conditional logic. A media input 102 can be considered to represent a data processing workflow if it includes identifiable elements or patterns that can be interpreted (e.g., visually, audibly, or contextually) as components of a structured data process, such as data movement, transformation, routing, or control logic. In some cases, multiple modalities may be combined within a single media input 102 (e.g., a video that includes both spoken narration and a visual diagram). In cases where a media input includes multiple modalities, the computing system 114 may analyze each channel separately or fuse the information to construct a unified interpretation of the workflow.

To support diverse use cases, the computing system 114 may be configured to validate the media input 102 upon receipt. Validation may include, for example, checking the file type against supported formats (e.g., Joint Photographic Experts Group (JPEG), Portable Network Graphics (PNG), Moving Picture Experts Group Layer 4 (MP4), or Waveform Audio File Format (WAV)), assessing the quality or resolution of an image to determine suitability for analysis, or verifying that an audio input includes recognizable speech patterns. In some embodiments, feedback may be provided if the media input 102 lacks sufficient information for downstream processing, allowing users to revise or re-submit their media input 102.

The example method depicted in FIG. 1 also includes analyzing 106, by the computing system 114, the media input 102 using one or more artificial intelligence models to detect a plurality of pipeline components 108. After receiving 104 the media input 102 representing a data processing workflow, the computing system 114 can initiate an analysis phase to extract pipeline-related semantic content from the media input 102. This analysis may be performed using one or more artificial intelligence models configured to interpret media data, such as images, audio, video, or combinations thereof, and identify structures or elements indicative of pipeline behavior.

The artificial intelligence models may include, for example, computer vision models, natural language models, speech recognition models, or combinations of these depending on the modality of the input. For media inputs containing visual information, such as diagrams or screenshots, the computing system 114 may employ object detection models to identify graphical symbols (e.g., boxes, arrows, data flow icons) and text recognition models to extract embedded labels. These models may be trained on labeled datasets of pipeline diagrams, annotated workflows, visual programming interfaces, or in some other ways. In some implementations, the computing system 114 may use segmentation or layout analysis techniques to isolate regions of interest that correspond to individual components.

For media inputs containing audio data, the computing system 114 may apply an automatic speech recognition (ASR) model to generate a transcript of spoken content. This transcript may then be passed to a natural language model capable of identifying textual constructs that describe pipeline behavior. For example, the model may detect entities such as data sources, filters, transformations, or destinations based on learned syntactic and semantic patterns. If the media input 102 is a video, the computing system 114 may extract key frames, transcribe associated audio, and analyze visual and textual content either separately or in combination.

In some embodiments, the computing system 114 can employ a pipeline of models rather than a single unified model. For example, a first model may segment a visual input into candidate regions, while a second model classifies the regions into component types. Similarly, a language model may refine or validate output produced by a vision model to ensure consistent labeling. Model selection and configuration may be adaptive based on the media type, the confidence of earlier processing steps, or user-specified preferences.

The output of analyzing 106 the media input 102 using one or more artificial intelligence models can be a plurality of detected pipeline components 108. Each pipeline component 108 can include a type (e.g., source, transformation, conditional, sink), an associated label or name, and optional metadata such as spatial coordinates, temporal markers, or confidence scores. These pipeline components 108 can be prepared for use in downstream steps that determine their inter-relationships and convert them into a structured pipeline definition, as will be explained in greater detail below.

This approach allows the computing system 114 to flexibly support multiple input formats and extract consistent semantic meaning from informal or unstructured representations. By leveraging one or more artificial intelligence models that are tailored to the modality and structure of the input, the computing system 114 can robustly identify the functional elements of a data pipeline across a wide range of usage contexts.

The example method depicted in FIG. 1 also includes determining 110, by the computing system 114, an arrangement of the pipeline components 108 based on relationships inferred from the media input 102. After the computing system 114 detects individual pipeline components 108 from the media input 102, the computing system 114 can determine 110 how those pipeline components 108 are positioned in relation to one another within the intended workflow. This arrangement reflects the logical structure of the pipeline, including the order of operations, dependencies between components, and possible control or data flows. The computing system 114 can identify this structure by interpreting various features present in the media input 102 that imply relationships between pipeline components 108.

For media inputs 102 containing visual content, the computing system 114 may evaluate spatial layout, orientation, and visual connectors. For example, components within the media input 102 that are placed near each other may be interpreted as sequential steps. Arrows or lines that connect components within the media input 102 may indicate directionality, suggesting that data or execution proceeds from one component to the next. Components within the media input 102 that are arranged in vertical or horizontal alignment may also imply ordered execution. In some cases, enclosing shapes or grouping indicators may signal that certain components function together as a unit.

For inputs that include natural language, either as written text or transcribed audio, the computing system 114 may analyze the phrasing and context to infer relationships. Words that indicate sequencing, including terms like “next,” “after,” or “then,” may help the computing system 114 understand the intended order of operations. Descriptions that reference the output of one operation being used in a subsequent operation can indicate a dependency relationship between components.

When the media input 102 is a video, for example, the computing system 114 may analyze the timing and sequence in which components appear or are discussed. A component that is drawn, referenced, or highlighted earlier may be treated as preceding others. The computing system 114 can combine information from visual and audio channels to determine how different elements relate within a single time-based context.

To establish a formal arrangement, the computing system 114 may represent components and their relationships using a directed graph or other structured model. Each node in the graph may correspond to a pipeline component 108, and each edge may represent a relationship such as sequencing or conditional flow. The relationships may be derived using pattern recognition, probabilistic models, or heuristics based on the context in which the media input 102 was created. The result of this process can be a structured arrangement that reflects how the components 108 are intended to operate together. This arrangement can provide the foundation for generating a complete pipeline definition that can be further configured or executed by the computing system 114 or some other execution platform, as will be described in greater detail below.

The example method depicted in FIG. 1 also includes generating 112, by the computing system 114, a data pipeline definition 116 comprising the pipeline components and their arrangement for execution within a processing environment. Following the identification of pipeline components 108 and their inferred arrangement, the computing system 114 can generate a data pipeline definition 116 that represents a complete workflow capable of being executed in a processing environment. The data pipeline definition 116 can includes each pipeline component 108, along with the logical structure that defines the order, dependencies, and relationships between the components 108.

The data pipeline definition 116 may be expressed in a structured format, such as a configuration file, serialized object, domain-specific language, or other representation compatible with a target orchestration engine and/or processing environment. Each pipeline component 108 can be described by a type, such as a data source, transformation operation, filter, join, or output node. In cases where complete configuration information is not available, the computing system 114 may insert placeholder values or default parameters to allow for later completion.

The arrangement of components 108 in the data pipeline definition 116 can reflect the relationships inferred from the media input 102. This can include sequential flows, parallel branches, conditional paths, and looping constructs, depending on what was present or implied in the original media input 102. The resulting data pipeline definition 116 can be organized to pre-serve execution semantics and structural coherence.

The computing system 114 may validate the generated data pipeline definition 116 to ensure that it is syntactically complete and meets requirements for deployment within the target environment. If the data pipeline definition 116 is intended for user review, the computing system 114 may present it in a visual editor or configuration interface, allowing the user to inspect, modify, or complete any unspecified fields. In other cases, the data pipeline definition 116 may be passed directly to an orchestration engine and/or execution platform for execution, scheduling, or integration into a broader workflow.

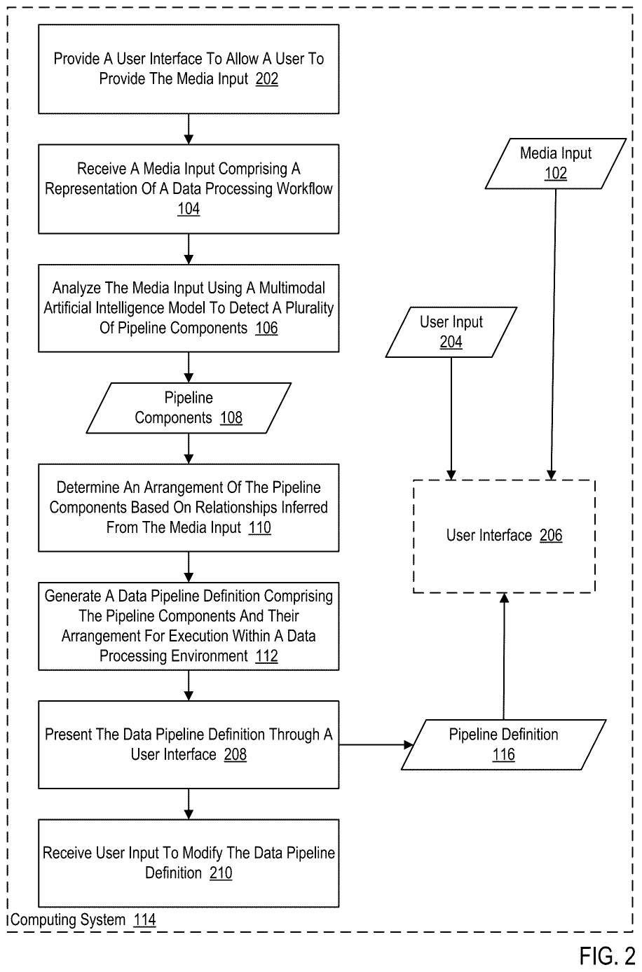

For further explanation, FIG. 2 sets forth a flow chart illustrating an additional example of a computer-implemented method for generating a data pipeline from media input 102 in accordance with some embodiments of the present disclosure. The example method depicted in FIG. 2 includes providing 202 a user interface 206 to allow a user to provide the media input 102. The computing system 114 can provide 202 the user interface 206, for example, by executing computer program instructions stored in memory of the computing system 114 that define the layout, behavior, input-handling functionality, or other aspects of the user interface 206. These instructions may be part of a dedicated application, a web-based front end, or an interface module integrated into a larger software platform.

The rendered user interface 206 may include visual components such as buttons, input fields, file selectors, and drag-and-drop regions. The interface can be configured to accept input events from the user (where the user can be an application, automated process, human user). In response to these interactions, the computing system 114 may trigger routines that access file selection dialogs, capture devices, or other input sources. The interface may invoke operating system services or browser APIs to open select files, initiate access to a camera or microphone, allow the user to paste a link or path to a media resource, or provide the media input 102 in some other way. Once the user selects or captures a media input 102, the interface can collect and forward the corresponding data to other components in the computing system 114 for validation and analysis. Through this process, the computing system actively presents and manages an interactive environment in which the user can supply media input in a controlled and accessible manner, initiating the pipeline generation workflow.

The example method depicted in FIG. 2 also includes presenting 208 the data pipeline definition 116 through a user interface 206. The computing system 114 can present 208 the data pipeline definition 116 through a user interface 206, for example, by executing software that generates a representation of the data pipeline definition 116 (or the data pipeline that is described in the data pipeline definition 116) and displays the representation. This may include, for example, rendering a visual layout of the pipeline components and their relationships, displaying a textual or structured form of the data pipeline definition 116, or presenting some other representation of the data pipeline described in the data pipeline definition 116. The user interface 206 may show each pipeline component as an individual element, along with lines, connectors, or other indicators that reflect the arrangement and flow between components.

The presentation may occur within a graphical editor, a configuration panel, or any other part of the user interface 206 designed to support review and interaction of the data pipeline definition 116 (or the data pipeline that is described in the data pipeline definition 116). The computing system 114 may update the display dynamically as the data pipeline definition 116 (or the data pipeline that is described in the data pipeline definition 116) is generated or modified. In some embodiments, the user interface 206 allows the user to interact with the presentation by viewing details, navigating the structure, or making adjustments. In other embodiments, the presentation is read-only and serves to confirm the generated output before execution or deployment.

The example method depicted in FIG. 2 includes receiving 210 user input 204 to modify the data pipeline definition 116. The computing system 114 can receive 210 user input 204 to modify the data pipeline definition 116, for example, by executing software that monitors and responds to interactions within the user interface 206. When the data pipeline definition 116 is presented 208, the user interface 206 may include interactive elements that allow the user (or an automated process) to select components, change properties, reposition elements, adjust the logical structure of the pipeline, modify parameters, or change some other aspect of the data pipeline definition 116. These interactions may include mouse clicks, keyboard entries, touch gestures, or other input events, depending on the form of the interface.

The computing system 114 can detect these inputs through event-handling routines, input listeners, or using some other mechanism that is part of the user interface 206. When an input is received, the computing system 114 can interpret the action and update the underlying representation of the data pipeline definition 116 accordingly. For example, if the user selects a component and changes a parameter, the computing system 114 can modify the data structure associated with that component to reflect the new value. If the user rearranges components or alters connections between them, the computing system can update the arrangement and relationships in the data pipeline definition 116. In some embodiments, changes are immediately reflected in the visual or textual presentation of the data pipeline, providing real-time feedback. In others, modifications may be queued or staged for review before being finalized. This interaction may allow users to refine, correct, or extend the pipeline structure that was initially generated from the media input 102.

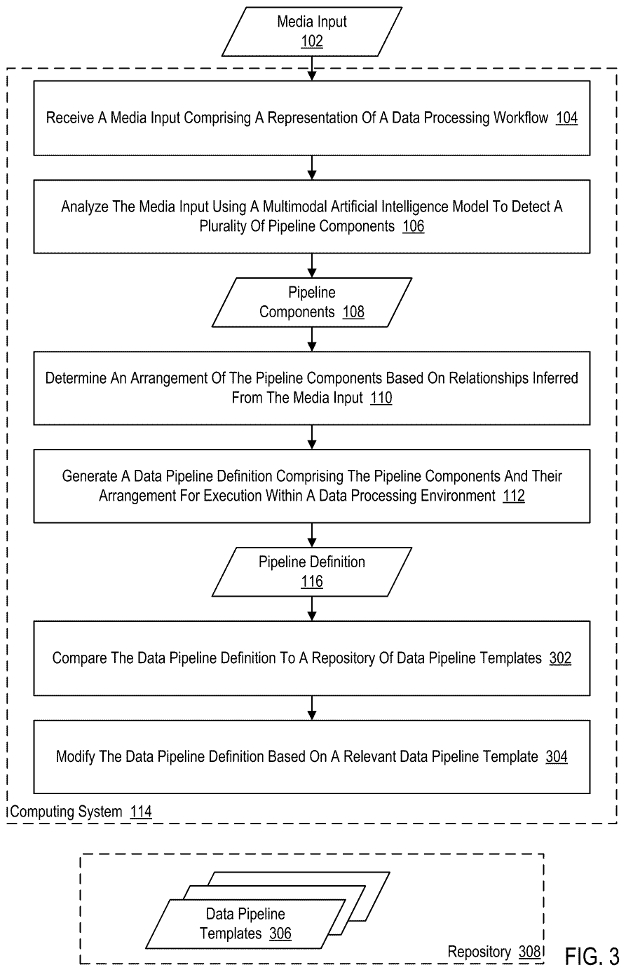

For further explanation, FIG. 3 sets forth a flow chart illustrating an additional example of a computer-implemented method for generating a data pipeline from media input 102 in accordance with some embodiments of the present disclosure. The example depicted in FIG. 3 also includes comparing 302 the data pipeline definition 116 to a repository 308 of data pipeline templates 306. The repository 308 depicted in FIG. 3 may be embodied, for example, as a database or other data store that contains a collection of data pipeline template 306 definitions, each representing a known configuration of pipeline components and relationships that reflect common practices, optimized architectures, or specific processing goals. The computing system 114 can compare the data pipeline definition 116 to one or more of the data pipeline templates 306 in the repository 308, for example, by executing logic that evaluates the structure and components of the generated data pipeline definition 116 against predefined pipeline patterns. To perform the comparison, the computing system 114 may extract relevant features from the data pipeline definition 116, including component types, execution sequences, branching logic, and overall topology. These features are then matched against corresponding features of data pipeline templates 306 stored in the repository 308. The computing system 114 may use structural matching techniques, pattern recognition, rule-based scoring, or similarity metrics to determine whether the data pipeline definition 116 aligns with or deviates from one or more data pipeline templates 306 in the repository 308. To perform the comparison, in some embodiments the computing system 114 may extract structural features from the generated pipeline, such as the number of components, their types, and their connectivity pattern. These features may be represented as a graph or a simplified structural signature. The computing system 114 can then compares these features to those associated with known templates using rule-based heuristics, graph similarity measures, or vectorized representations. Matching may be binary or weighted, allowing the computing system 114 to identify exact or partial matches and rank candidate templates accordingly.

The repository 308 may be stored locally or remotely, and it may include data pipeline templates 306 that are defined in the same format as the pipeline definition 116, or in an abstract form that is translated (e.g., at runtime). The comparison process may result in the identification of one or more matching data pipeline templates 306, or it may indicate partial alignment that could support further optimization or validation.

The example depicted in FIG. 3 also includes modifying 304 the data pipeline definition 116 based on a relevant data pipeline template 306. After identifying a relevant data pipeline template 306 from the repository 308, the computing system 114 can modify 304 the data pipeline definition 116 to align with the structure, configuration, or best practices reflected in the selected relevant data pipeline template 306. This modification of the data pipeline definition 116 can include, for example, adjusting the sequence or arrangement of components to align with the relevant data pipeline template 306 (in order to conform to the template), inserting additional operations that are commonly included in the relevant data pipeline template 306, replacing components with alternatives that better conform to the relevant data pipeline template 306, or modifying 304 the data pipeline definition 116 in some other way to create better alignment with the relevant data pipeline template 306.

The computing system 114 can perform this modification by executing instructions that apply transformation rules or mappings derived from the relevant data pipeline template 306. These may involve substituting default parameters, updating component types, or inserting scaffolding that supports robustness, performance, or maintainability. For example, the computing system 114 may insert error-handling branches, intermediate validation steps, or staging layers that are part of the relevant data pipeline template 306 but not present in the original data pipeline definition 116.

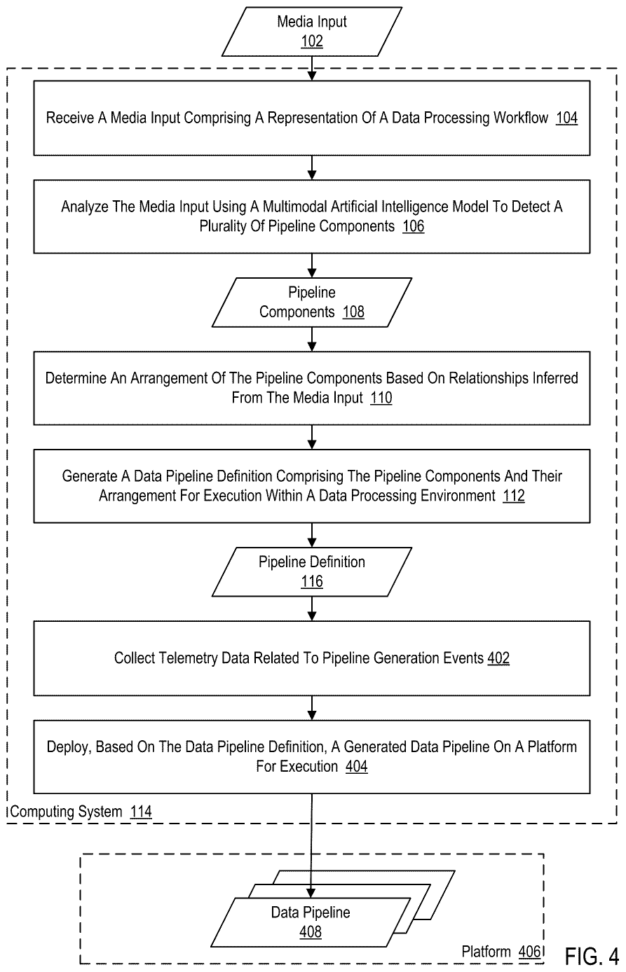

For further explanation, FIG. 4 sets forth a flow chart illustrating an additional example of a computer-implemented method for generating a data pipeline from media input 102 in accordance with some embodiments of the present disclosure. The example method depicted in FIG. 4 includes deploying 404, based on the data pipeline definition 116, a generated data pipeline 406 on a platform for execution 408. The computing system 114 can be configured to performs deploy 404 a generated data pipeline 406 by leveraging one or more software components that handle integration with external execution environments (e.g., a platform for execution 408). These software components may be part of the computing system 114 that generated the pipeline, or they may be separate services responsible for orchestration and deployment.

The generated data pipeline 406 can refer to an operational version of the pipeline that is described in the data pipeline definition 116, which can include fully specified components, resolved configuration values, or any additional metadata required for execution. The generated data pipeline 406 can represents a concrete, executable form of the abstract structure previously defined. The generated data pipeline 406 can be packaged, for example, as a structured artifact that encodes the components of the pipeline, their configuration properties, and the relationships among them. This artifact can be formatted as a machine-readable document, using formats such as JSON, YAML, or another schema supported by the targeted platform for execution 408. The structure can include identifiers for each pipeline component, execution order, input and output mappings, and any parameters or runtime settings needed to support execution. In some implementations, the packaged pipeline can also include layout metadata for use in graphical interfaces.

Packaging the generated data pipeline 406 may be performed by software modules within the computing system 114 that serialize the in-memory representation of the pipeline into a persistent or transmittable format. Depending on the platform for execution 408, the packaged artifact may be submitted as a deployment payload, stored in a repository, or bundled with auxiliary configuration files or scripts. The packaged pipeline may be configured to comply with the syntactic and structural requirements of the target execution environment to ensure that it can be correctly interpreted and executed upon deployment.

The data pipeline definition 116 can serve as the source for the generated data pipeline 406. This data pipeline definition 116 contains the component types, their relationships, and any parameters or properties associated with each component. Before deployment, the computing system may augment this data pipeline definition 116 with runtime information, such as environment-specific variables, credentials, scheduling metadata, or resource constraints. These enhancements ensure that the generated data pipeline 406 is compatible with the target execution environment.

The platform for execution 408 may include a wide range of systems that support orchestrated data processing such as, for example, a data integration platform that can run on cloud, edge, or on-premise. In some embodiments, the platform for execution 408 may be a cloud-based service, such as a managed ETL or ELT platform, a container orchestration system like Kubernetes, or a batch or stream processing engine. In some embodiments, the data integration platform can support different data delivery styles (e.g., batch, micro-batch/change data capture and real-time data integration). Alternatively, the platform for execution 408 may be a local integration engine, a workflow scheduler, or a distributed processing framework like Microsoft Fabric Data Factory, Azure Data Factory, SQL Server Integration Services (SSIS), open-source framework like Apache Airflow, or similar technologies.

To carry out the deployment, the computing system 114 may serialize the generated data pipeline 406 into a structured format accepted by the platform for execution 408, such as JSON, XML, other text based representation, or a proprietary pipeline specification. The system then transmits this serialized representation to the platform for execution 408 through an application programming interface, deployment endpoint, message queue, or file-based handoff. In some implementations, the computing system 114 invokes a remote service or uses a software development kit to register the pipeline for execution. In other cases, it may place the pipeline into a monitored directory, trigger a webhook, or call a deployment script that handles the transfer and registration process.

Deployment may also include preparatory steps. These can include validating the pipeline structure, testing connections to data sources and sinks, assigning execution roles or permissions, or selecting the target environment (for example, development, staging, or production). Once deployment is complete, the generated data pipeline 406 becomes available within the platform's scheduling or triggering framework and can be executed based on defined triggers, user input, or recurring schedules. Through this deployment process, the computing system 114 can enable the pipeline to transition from a static definition to an active, executable workflow that is ready to perform data processing tasks in a real-world environment.

The example depicted in FIG. 4 also includes collecting 402 telemetry data related to pipeline generation events. The computing system 114 can collect 402 telemetry data by executing software routines that monitor and log specific activities occurring during the pipeline generation process. Telemetry data can refer, for example, to structured records or metrics that describe the behavior, status, and outcomes of operations performed by the computing system 114. In the context of pipeline generation, this may include information such as the type of media input received, the number of pipeline components detected, the time taken for each processing step, the accuracy or confidence scores associated with component recognition, and whether the resulting pipeline was accepted, edited, or deployed by the user.

To collect this data, the computing system 114 can include instrumentation logic that triggers at defined points within the generation workflow. These points may include the receipt of media input, the invocation of artificial intelligence models, the completion of the arrangement step, the generation of the final pipeline definition, or at some other point. At each point, the computing system 114 may create log entries, emit structured events, and so on. These data points may be stored locally in memory, written to log files, transmitted to remote telemetry services for aggregation and analysis, or sent to some other downstream workflow. In some cases, the telemetry data may include user interaction signals, such as feedback on pipeline quality, acceptance of suggested modifications, or cancellation of the generation process. The collected telemetry data can support real-time monitoring, retrospective analysis, debugging, and system optimization. It may also be used to improve future pipeline generation outcomes by informing model retraining, feature tuning, or user interface adjustments.

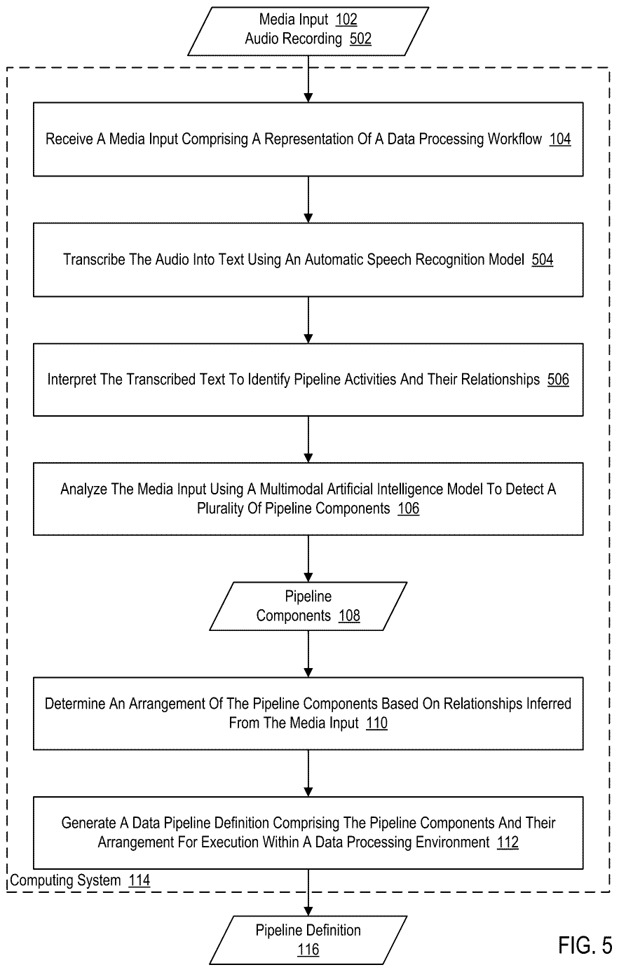

For further explanation, FIG. 5 sets forth a flow chart illustrating an additional example of a computer-implemented method for generating a data pipeline from media input 102 in accordance with some embodiments of the present disclosure. In the example depicted in FIG. 5, the media input 102 includes an audio recording 502. The audio recording 502 may be generated, for example, by a user speaking into a microphone connected to the computing system 114, by uploading a pre-recorded audio recording 502 to the computing system 114, or in some other way. The audio recording 502 can capture the user's intent regarding the structure and behavior of the desired data pipeline, including references to data sources, processing steps, and output destinations. This audio recording 502 can serve as one modality through which the computing system 114 can interpret and generate a corresponding pipeline.

The example method depicted in FIG. 5 also includes transcribing 504 the audio recording 502 into text using an automatic speech recognition model. The computing system 114 may transcribe 504 the audio recording 502 into text by executing software routines that apply an automatic speech recognition (ASR) model. The audio recording 502 may contain a spoken description of a data processing workflow and may be provided as a pre-recorded file or captured in real time through a microphone. The ASR model can convert the spoken content into written text that reflects the speaker's intent, including references to data sources, transformation steps, and output targets that are expected to be part of the data pipeline.

Before or during transcription, the computing system 114 may perform additional preprocessing on the audio recording 502 to improve recognition accuracy and enable richer downstream interpretation. This may include applying noise reduction filters, enhancing speech clarity, or segmenting the audio recording 502 to distinguish between different speakers or phases of the workflow description. In some implementations, the computing system 114 may perform time-stamp alignment to link specific phrases to temporal segments of the input, or it may apply domain-tuned keyword spotting models to highlight terminology associated with pipeline components. The ASR model may be adapted to support specific languages, accents, or speaking styles, depending on deployment context. The resulting text output can be stored in memory of the computing system 114 and may become the basis for further analysis by natural language understanding models. These models can extract pipeline semantics from the transcript, allowing the system to identify components and generate an initial pipeline structure consistent with the user's spoken instructions.

The example method depicted in FIG. 5 also includes interpreting 506 the transcribed text to identify pipeline activities and their relationships. The computing system 114 can interpret the transcribed text by executing one or more natural language processing (NLP) models or rule-based parsing systems that extract semantic meaning from the text. The transcribed text, which is produced from an audio recording, can contains a written version of a verbal description of a data processing workflow. This text can include, for example, references to specific steps in the pipeline, such as extracting data from a source, applying transformations, handling conditions, or writing output to a destination.

To identify pipeline activities, the computing system 114 can analyze the text to detect phrases or sentence patterns that describe functional steps. For example, the phrase “read customer data from storage” may be interpreted as a source activity, while “filter for active accounts” may correspond to a transformation activity. The computing system 114 may use entity recognition models, intent classification techniques, or pattern-matching rules to map textual expressions to corresponding pipeline component types.

To identify relationships between activities, the computing system 114 may extract temporal or causal language that implies ordering or dependency. Phrases such as “then,” “after that,” or “once completed” suggest sequencing, while constructs like “if it fails” or “otherwise” may signal conditional branching. The computing system 114 may also infer data dependencies from context, such as when the output of one step is referenced in a subsequent step. In some implementations, this interpretation can be formalized by constructing an intermediate graph structure where nodes represent activities and edges represent execution or data flow relationships. The resulting interpretation can provide a structured representation of the pipeline, which is passed to subsequent components for arrangement and generation of an executable definition.

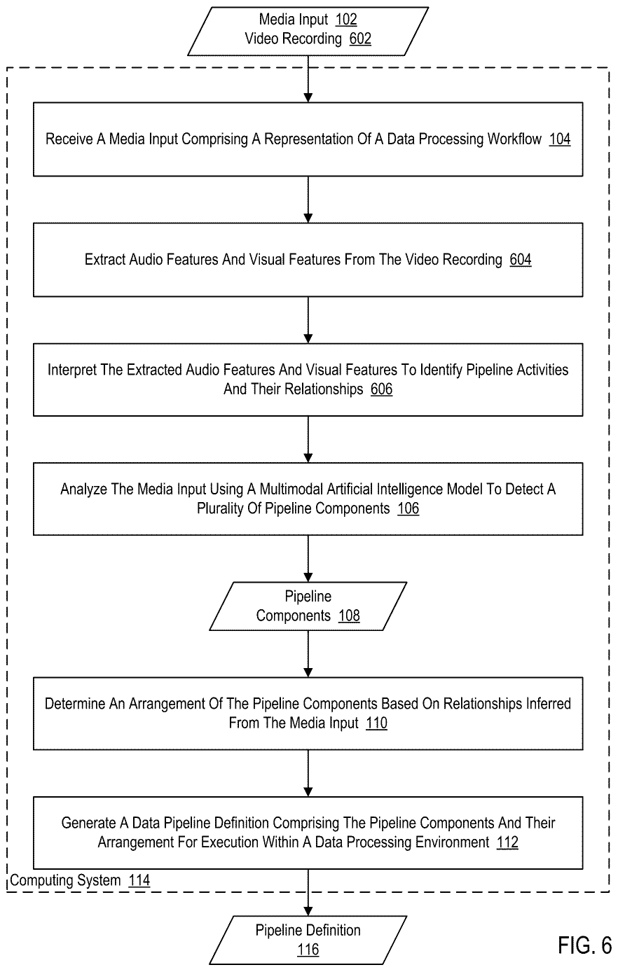

For further explanation, FIG. 6 sets forth a flow chart illustrating an additional example of a computer-implemented method for generating a data pipeline from media input 102 in accordance with some embodiments of the present disclosure. In the example depicted in FIG. 6, the media input 102 includes a video recording 602. The video recording 602 may be generated, for example, by a user during a live demonstration, using screen capture tools, during a whiteboard session or presentation, or in some other way. The video recording 602 can contain spoken narration, written text, hand-drawn diagrams, user interface interactions, or a combination of these elements. The computing system 114 can receive the video recording 602 as input and can prepare it for analysis by separating and processing its audio and visual components, as described in greater detail below.

The example method depicted in FIG. 6 also includes extracting 604 audio features and visual features from the video recording. The computing system 114 can extract 604 audio features and visual features from the video recording 602 in order to analyze the content and infer relevant aspects of a data processing workflow. The video recording 602 may contain a variety of informative content, including spoken narration, screen activity, diagram transitions, or a whiteboard demonstration. The computing system 114 may process the video recording 602 as a whole or decompose it into separate audio and visual streams, each handled by specialized components.

To extract audio features, the computing system 114 can initially isolate the audio track from the video. This may be done using standard multimedia decoding tools or audio separation techniques, as well as potentially converting the audio to text using AI models. In some embodiments, audio can be in different languages (e.g., English, Spanish). The computing system 114 can then analyze the audio using one or more models or algorithms. These may include automatic speech recognition models to transcribe spoken language, as well as acoustic feature extraction models that capture intonation, pauses, speaker emphasis, or domain-specific pronunciation. In some embodiments, the computing system 114 identifies patterns or keyword presence to guide intent extraction. Additional features may include timestamped segments, voice activity detection, or speaker segmentation.

To extract visual features, the computing system 114 can process individual frames or sequences of frames to detect pipeline-relevant visual content. In some embodiments, the computing system 114 samples key frames at regular intervals or identifies scene changes to capture meaningful transitions. Visual features may include shapes, lines, text, layout structures, motion vectors, or color regions. The computing system 114 may apply computer vision models, such as convolutional neural networks or transformer-based architectures, to detect labeled blocks, connectors, screen UI elements, or hand-drawn figures that correspond to pipeline components or relationships. Optical character recognition may be used to extract text embedded in the video recording 602, such as from slides or interface screenshots.

In some cases, the computing system 114 may extract temporal features across both modalities, capturing the timing of spoken references alongside visual changes to align multimodal events. This alignment may enables the computing system 114 to reason about pipeline structure using both what is said and what is shown. The extracted audio and visual features may be stored as intermediate representations (e.g., embeddings, token sequences, metadata arrays) that can be used by downstream components to interpret the overall workflow described in the video.

The example method depicted in FIG. 6 also includes interpreting 606 the extracted audio features and visual features to identify pipeline activities and their relationships. In the example method shown in FIG. 6, the computing system 114 can interpret the extracted audio features and visual features in order to identify pipeline activities and the relationships among those activities. The audio and visual features can be derived from the video recording 602 and can represent structured, machine-interpretable information that captures what is said and shown within the video recording 602.

To interpret audio features, the computing system 114 can analyze transcribed speech, acoustic patterns, or linguistic constructs that were extracted previously. Natural language processing models may be used to identify intent, extract action-oriented phrases, and detect key-words related to data operations. For instance, a phrase such as “load the results into the warehouse after filtering null values” may be parsed into two pipeline activities (filtering and loading) and an execution relationship (sequential ordering). Likewise, the phrase “load the data from Azure storage to data warehouse” may result in a single pipeline activity that copies data from storage to warehouse, with a SQL query that specifying the filter condition applied to source. The computing system 114 may also evaluate emphasis, pauses, or repetition in the speech signal to assess importance or grouping of activities.

For visual features, the computing system 114 may apply semantic segmentation, object recognition, layout analysis, or some other technique to identify distinct pipeline components in a diagram, UI recording, whiteboard sketch, and so on. Shapes, positions, connectors, and labels may be used to determine the type and role of each component. For example, a rectangular box labeled “copy” followed by an arrow leading to a circle labeled “send email” may copy the data and, on success, send an email. The computing system 114 may also interpret relative position and grouping to determine execution structure, including parallel branches, nested logic, or iterative loops.

In some embodiments, the computing system 114 performs multimodal reasoning by combining insights from both modalities. For instance, if a visual element appears while a corresponding activity is mentioned in narration, the computing system 114 may assign higher confidence to that component. When timing information is available, the computing system 114 may align spoken references to frame-level visual cues to better determine the structure and ordering of the pipeline. Discrepancies between modalities may be resolved using model confidence scores, predefined rules, or in some other way.

In some embodiments, after extracting audio and visual features, the computing system 114 may combine those inputs to form a unified understanding of the pipeline described in the video. In some embodiments, the computing system 114 can align time-stamped spoken phrases with visual frame content to associate narration with specific diagram components. For example, if a narrator describes a filtering step while pointing to or displaying a labeled box, the computing system 114 may strengthen the link between those elements. If there are inconsistencies between what is said and what is shown, the computing system 114 may use model confidence scores or predefined priority rules to resolve ambiguity. This fusion process enables the system to create a more accurate and coherent interpretation of the pipeline logic.

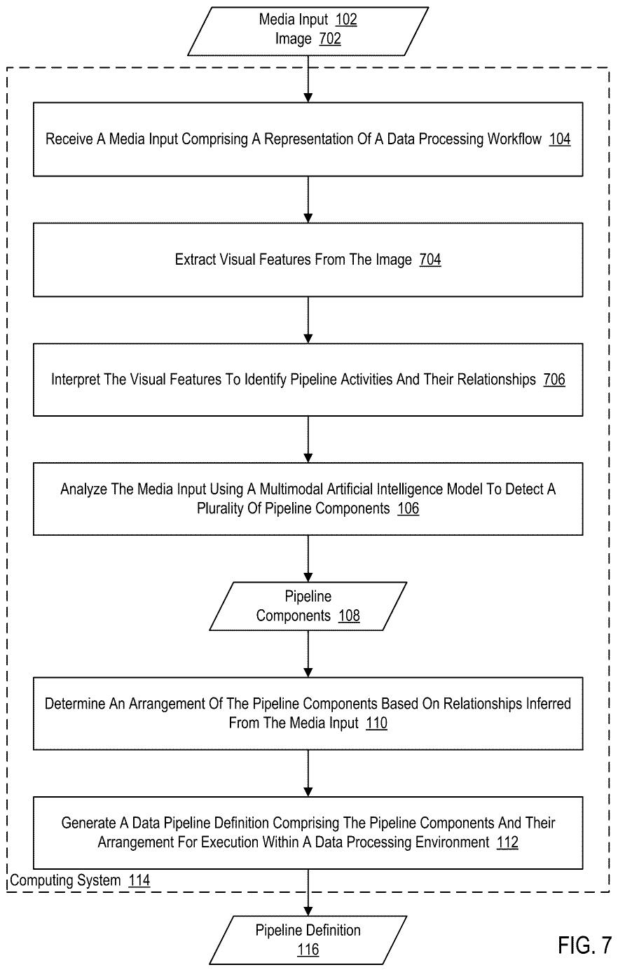

For further explanation, FIG. 7 sets forth a flow chart illustrating an additional example of a computer-implemented method for generating a data pipeline from media input 102 in accordance with some embodiments of the present disclosure. In the example depicted in FIG. 7, the media input 102 includes an image 702. The image 702 may be captured using a camera, such as by photographing a whiteboard drawing or sketch, created digitally (e.g., through a diagramming application, by taking a screenshot of a pipeline editor or legacy integration tool), or captured in some other way. The image 702 can be uploaded by the user from local storage, captured in real time through an input device, retrieved from a remote source, or obtained in some other way. Supported image formats include, for example, JPEG, PNG, GIF, TIFF, BMP, or other image encodings. The computing system 114 may also support images embedded in documents or extracted from video frames, depending on implementation.

The example depicted in FIG. 7 also includes extracting 704 visual features from the image. The computing system 114 can perform visual feature extraction, for example, by analyzing the image 702 to detect graphical and textual elements that may represent parts of a data pipeline. This may involve applying one or more computer vision models (or large language/vision models) to identify boxes, arrows, connector lines, flow indicators, and other diagrammatic structures. Optical character recognition may also be used to extract any text embedded in or near these graphical elements. Additional techniques may include edge detection, layout segmentation, and color or shape classification to distinguish between different types of components or relationships.

The example depicted in FIG. 7 also includes interpreting 706 the visual features to identify pipeline activities and their relationships. Once features have been extracted, the computing system 114 can proceed to interpret the visual content to identify pipeline activities (e.g., data ingestion, transformation, filtering, output) and the relationships between those activities. Relationships may be inferred based on directional connectors (for example, an arrow from one box to another), spatial positioning (such as left-to-right or top-down ordering), proximity, or visual grouping. In some cases, the computing system 114 can construct an internal representation, such as a directed graph or tree, to model the structure of the pipeline. The interpretation process may incorporate both geometric analysis and contextual clues from extracted text to disambiguate component types and their execution order. Through this process, the system is able to transform a static image into a structured representation of a data pipeline, providing a foundation for generating an executable workflow that reflects the original visual design.

The pipeline activities referenced above can include a variety of tasks. For example, the pipeline activities can include data ingestion, preprocessing, feature extraction, model execution, vector indexing orchestration, or some other task. The pipeline activities that are identified and interpreted by the computing system 114 can represent discrete operations that are intended to be executed as part of a broader data processing workflow. These activities can vary in function and complexity, depending on the domain and the intent expressed in the media input 102. In general, a pipeline activity corresponds to a unit of work that transforms data or directs the flow of data through the pipeline.

For example, data ingestion can involve reading or retrieving data from a source system, such as a database, data lake, file system, or API. Preprocessing can refer to operations that clean, normalize, or restructure data to prepare it for downstream tasks. This may include filtering, deduplication, type casting, or missing value handling. Feature extraction can involve deriving structured features from raw data, often used in machine learning workflows to prepare data for model input. Model execution can refer to invoking a trained machine learning model on processed data to produce predictions, classifications, or other outputs. Vector indexing orchestration can involve transforming textual, image, or structured data into vector embeddings and managing their insertion into vector search engines or databases, often to support similarity search or retrieval-augmented generation. Other pipeline activities may include data joining, aggregation, conditional branching, enrichment from external sources, or writing final outputs to one or more destinations. These tasks may be explicitly identified in the media input 102 or inferred from context, and the computing system 114 can be configured to support a wide range of activity types during pipeline generation and execution

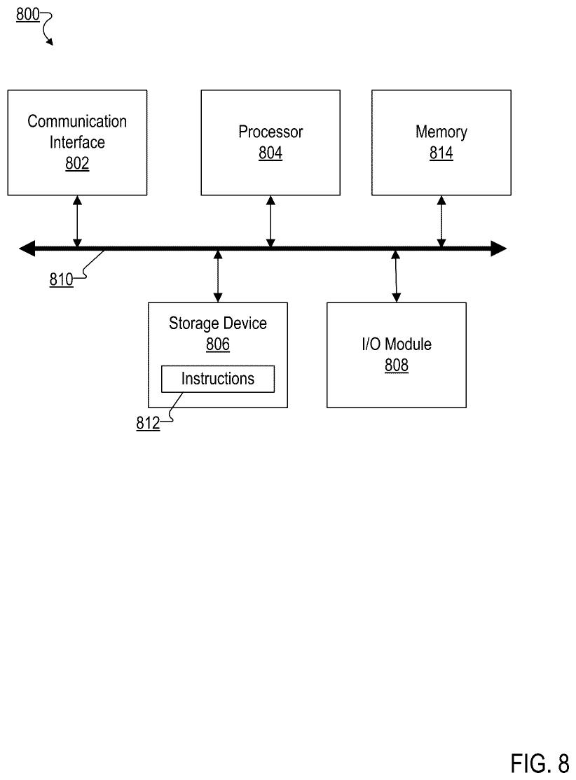

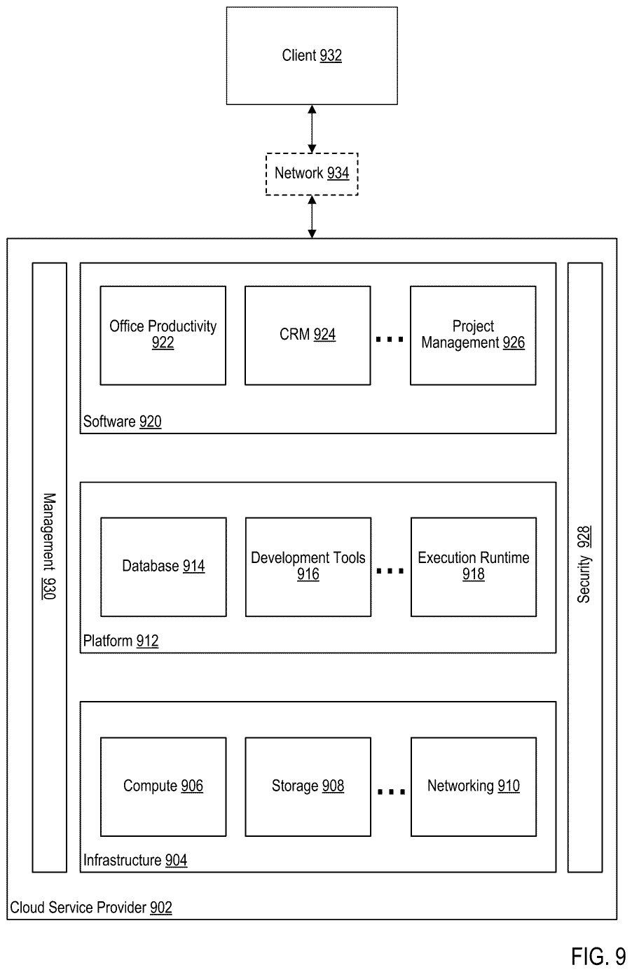

For further explanation, the sections included below provide some details regarding technologies that may be used to generate a data pipeline from media input in accordance with some embodiments. For example, FIG. 8 sets forth an example of a computing device that may be used for some portion of generating a data pipeline from media input in accordance with some embodiments. As an additional example of technologies that may be used to generate a data pipeline from media input, FIG. 9 sets forth a block diagram of a cloud service provider 902 service architecture in accordance with some embodiments of the present disclosure.

For further explanation, FIG. 8 illustrates an exemplary computing device 800 that may be specifically configured to perform one or more of the processes described herein. As shown in FIG. 8, computing device 800 may include a communication interface 802, a processor 804, a storage device 806, an input/output (I/O) module 808, and computer memory 814 communicatively connected one to another via a communication infrastructure 810. While an exemplary computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit capable of processing data and/or interpreting, executing, and/or directing execution of one or more of the instructions, processes, and/or operations described herein. Processor 804 may perform operations by executing computer-executable instructions 812 (e.g., an application, software, code, and/or other executable data instance) stored in storage device 806.

Storage device 806 may include one or more data storage media, devices, or configurations and may employ any type, form, and combination of data storage media and/or device. For example, storage device 806 may include, but is not limited to, any combination of non-volatile media and/or volatile media. Electronic data, including data described herein, may be temporarily and/or permanently stored in storage device 806. For example, data representative of computer-executable instructions 812 configured to direct processor 804 to perform any of the operations described herein may be stored within storage device 806. In some examples, data may be arranged in one or more databases residing within storage device 806.

I/O module 808 may include one or more I/O modules configured to receive user input and provide user output. I/O module 808 may include any hardware, firmware, software, or combination thereof supportive of input and output capabilities. For example, I/O module 808 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 800.

For further explanation and as an additional example of a supporting technology for the embodiments described here, FIG. 9 sets forth a block diagram of a cloud service provider service architecture in accordance with some embodiments. The cloud service provider 902 can deliver a variety resources through a services-based consumption model where resources are consumed on-demand and as-a-service. Cloud service providers can provide services via cloud platforms such as, for example, Microsoft Azure™, Amazon Web Services (‘AWS’)™, Google Cloud Platform (‘GCP’)™, and others. In FIG. 9, the cloud service provider 902 is accessed from a client device 934 via a network 932.

FIG. 9 depicts an embodiment where software 920 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 9, as examples of software 920 that can be delivered as-a-service, the illustrated embodiment includes office productivity 922 software, customer relationship management (‘CRM’) 924 software, and project management 926 software. The office productivity 922 software can include applications designed to facilitate common business and personal tasks, including word processing applications, applications for spreadsheet creation, presentation design applications, and many others. The CRM 924 software can include applications for managing a business organization's relationships and interactions with customers and potential customers. The project management 926 software can include applications designed to help teams plan, organize, and manage projects efficiently by facilitating collaboration and tracking the progress of projects. Readers will appreciate that in other embodiments, other types of software may be delivered using a SaaS model.

FIG. 9 depicts an embodiment where platforms 912 can be delivered as a service. Plat-form-as-a-service (‘PaaS’) is a model that provides cloud customers with platform resources that they can use to develop, run, and manage applications without the complexity of such deploying and managing such infrastructure on their own. In FIG. 9, as examples of platform 912 resources that can be delivered as-a-service, the illustrated embodiment includes database 914 services, development tools 916 services, and execution runtime 918 services. The database 914 services can be used to provide access to databases without management overhead for the user as the cloud service provider manages the provisioning, scaling, and maintenance of the databases. The development tools 916 services can provide developers with tools to design, develop, test, and deploy applications without needing to manage the underlying infrastructure. The execution runtime 918 services can provide environments where applications or other forms of computer program code can be executed, including services to scale the execution environment. Readers will appreciate that in other embodiments, other platform resources may be delivered using a IaaS model.

FIG. 9 depicts an embodiment where infrastructure 904 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 9, as examples of infrastructure 904 resources that can be delivered as-a-service, the illustrated embodiment includes compute 906 services, storage 908 services, and networking 910 services. The compute 906 services can be used to provide on-demand access to computational resources such as VMs, containers, and serverless functions, where the cloud service provider manages the provisioning, scaling, and maintenance of such resources. The storage 908 services can provide storage resources that can be used to store and access data, without the need for customers to purchase and manage on-premises physical storage resources. The networking 910 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud service provider of FIG. 9 also provides management 930 resources. The management 930 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 9 also provides security 928 resources. The security 928 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:

Here are the corresponding statements for each of the claims, formatted according to your instructions:
1. A computer-implemented method for generating a data pipeline from media input, the method comprising: receiving, by a computing system, a media input comprising a representation of a data processing workflow; analyzing, by the computing system, the media input using one or more artificial intelligence models to detect a plurality of pipeline components; determining, by the computing system, an arrangement of the pipeline components based on relationships inferred from the media input; and generating, by the computing system, a data pipeline definition comprising the pipeline components and their arrangement for execution within a processing environment.
2. The computer-implemented method of any combination of one or more of the statements above, further comprising: presenting the data pipeline definition through a user interface; and receiving user input to modify the data pipeline definition.
3. The computer-implemented method of any combination of one or more of the statements above, further comprising providing a user interface to allow a user to provide the media input.
4. The computer-implemented method of any combination of one or more of the statements above, further comprising comparing the data pipeline definition to a repository of data pipeline templates.
5. The computer-implemented method of any combination of one or more of the statements above, further comprising modifying the data pipeline definition based on a relevant data pipeline template.
6. The computer-implemented method of any combination of one or more of the statements above, further comprising deploying, based on the data pipeline definition, a generated data pipeline on a platform for execution.
7. The computer-implemented method of any combination of one or more of the statements above, further comprising collecting telemetry data related to pipeline generation events.
8. The computer-implemented method of any combination of one or more of the statements above, wherein the media input comprises an image, the method further comprising: extracting visual features from the image; and interpreting the visual features to identify pipeline activities and their relationships.
9. The computer-implemented method of any combination of one or more of the statements above, wherein the media input comprises an audio recording, the method further comprising: transcribing the audio recording into text using an automatic speech recognition model; and interpreting the transcribed text to identify pipeline activities and their relationships.
10. The computer-implemented method of any combination of one or more of the statements above, wherein the media input comprises a video recording, the method further comprising: extracting audio features and visual features from the video recording; and interpreting the extracted audio features and visual features to identify pipeline activities and their relationships.
11. An apparatus for securing an operating system, comprising: a memory; and one or more processing devices, operatively coupled to the memory, the one or more processing devices configured to: receive a media input comprising a representation of a data processing workflow; analyze the media input using one or more artificial intelligence models to detect a plurality of pipeline components; determine an arrangement of the pipeline components based on relationships inferred from the media input; and generate a data pipeline definition comprising the pipeline components and their arrangement for execution within a processing environment.
12. The apparatus of any combination of one or more of the statements above wherein the one or more processing devices are further configured to: present the data pipeline definition through a user interface; and receive user input to modify the data pipeline definition.
13. The apparatus of any combination of one or more of the statements above wherein the one or more processing devices are further configured to provide a user interface to allow a user to provide the media input.
14. The apparatus of any combination of one or more of the statements above wherein the one or more processing devices are further configured to compare the data pipeline definition to a repository of data pipeline templates.
15. The apparatus of any combination of one or more of the statements above wherein the one or more processing devices are further configured to modify the data pipeline definition based on a relevant data pipeline template.
16. The apparatus of any combination of one or more of the statements above wherein the one or more processing devices are further configured to deploy, based on the data pipeline definition, a generated data pipeline on a platform for execution.
17. The apparatus of any combination of one or more of the statements above wherein the one or more processing devices are further configured to collect telemetry data related to pipeline generation events.
18. The apparatus of any combination of one or more of the statements above wherein the media input comprises an audio recording and the one or more processing devices are further configured to: transcribe the audio recording into text using an automatic speech recognition model; and interpret the transcribed text to identify pipeline activities and their relationships.
19. The apparatus of any combination of one or more of the statements above wherein the media input comprises a video recording the one or more processing devices are further configured to: extract audio features and visual features from the video recording; and interpret the extracted audio features and visual features to identify pipeline activities and their relationships.
20. A non-transitory computer readable storage medium storing instructions which, when executed, cause a processing device to: receive a media input comprising a representation of a data processing workflow; analyze the media input using one or more artificial intelligence models to detect a plurality of pipeline components; determine an arrangement of the pipeline components based on relationships inferred from the media input; and generate a data pipeline definition comprising the pipeline components and their arrangement for execution within a processing environment.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 in-stances), in one or more serverless compute instances offered such as those offered by a cloud service provider, in one or more event-driven compute services such as those offered by a cloud service provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A computer-implemented method for generating a data pipeline from media input, comprising:
receiving, by a computing system, a media input comprising a representation of a data processing workflow;
analyzing, by the computing system, the media input using one or more artificial intelligence models to detect pipeline components;
determining, by the computing system, an arrangement of the pipeline components based on relationships inferred from the media input; and
generating, by the computing system, a data pipeline definition comprising the pipeline components and their arrangement for execution within a processing environment.

2. The computer-implemented method of claim 1, further comprising:
presenting the data pipeline definition through a user interface; and
receiving user input to modify the data pipeline definition.

3. The computer-implemented method of claim 1, further comprising providing a user interface to allow a user to provide the media input.

4. The computer-implemented method of claim 1, further comprising comparing the data pipeline definition to a repository of data pipeline templates.

5. The computer-implemented method of claim 4, further comprising modifying the data pipeline definition based on a relevant data pipeline template.

6. The computer-implemented method of claim 1, further comprising deploying, based on the data pipeline definition, a generated data pipeline on a platform for execution.

7. The computer-implemented method of claim 1, further comprising collecting telemetry data related to pipeline generation events.

8. The computer-implemented method of claim 1, wherein the media input comprises an image, the computer-implemented method further comprising:
extracting visual features from the image; and
interpreting the visual features to identify pipeline activities and their relationships.

9. The computer-implemented method of claim 1, wherein the media input comprises an audio recording, the computer-implemented method further comprising:
transcribing the audio recording into text using an automatic speech recognition model; and
interpreting the text to identify pipeline activities and their relationships.

10. The computer-implemented method of claim 1, wherein the media input comprises a video recording, the computer-implemented method further comprising:
extracting audio features and visual features from the video recording; and
interpreting the audio features and visual features to identify pipeline activities and their relationships.

11. An apparatus for securing an operating system, comprising:
a memory; and
one or more processing devices, operatively coupled to the memory, the one or more processing devices configured to:
receive a media input comprising a representation of a data processing workflow; analyze the media input using one or more artificial intelligence models to detect pipeline components;
determine an arrangement of the pipeline components based on relationships inferred from the media input; and
generate a data pipeline definition comprising the pipeline components and their arrangement for execution within a processing environment.

12. The apparatus of claim 11 wherein the one or more processing devices are further configured to:
present the data pipeline definition through a user interface; and
receive user input to modify the data pipeline definition.

13. The apparatus of claim 11 wherein the one or more processing devices are further configured to provide a user interface to allow a user to provide the media input.

14. The apparatus of claim 11 wherein the one or more processing devices are further configured to compare the data pipeline definition to a repository of data pipeline templates.

15. The apparatus of claim 14 wherein the one or more processing devices are further configured to modify the data pipeline definition based on a relevant data pipeline template.

16. The apparatus of claim 11 wherein the one or more processing devices are further configured to deploy, based on the data pipeline definition, a generated data pipeline on a platform for execution.

17. The apparatus of claim 11 wherein the one or more processing devices are further configured to collect telemetry data related to pipeline generation events.

18. The apparatus of claim 11 wherein the media input comprises an audio recording and the one or more processing devices are further configured to:
transcribe the audio recording into text using an automatic speech recognition model; and
interpret the text to identify pipeline activities and their relationships.

19. The apparatus of claim 11 wherein the media input comprises a video recording and the one or more processing devices are further configured to:
extract audio features and visual features from the video recording; and
interpret the audio features and visual features to identify pipeline activities and their relationships.

20. A non-transitory computer readable storage medium storing instructions which, when executed, cause a processing device to:
receive a media input comprising a representation of a data processing workflow;
analyze the media input using one or more artificial intelligence models to detect pipeline components;
determine an arrangement of the pipeline components based on relationships inferred from the media input; and
generate a data pipeline definition comprising the pipeline components and their arrangement for execution within a processing environment.
